(19) United States
(12) Patent Application Publication
(10) Pub. No.: US 2014/0209776 A1
(43) Pub. Date: Jul. 31, 2014

(54) Multi-sheet reading apparatus

(71) Applicant: Tehmaas Gorimaar, Doylestown, PA (US)

(72) Inventor: Tehmaas Gorimaar, Doylestown, PA (US)

(21) Appl. No.: 13/815,112

(22) Filed: Jan. 31, 2013

(51) Int. Cl. F16M 11/00

(52) U.S. Cl. CPC F16M 11/00
USPC 248/444.1; 248/447

(57) ABSTRACT

A support apparatus is disclosed for presenting successive printed sheets, such as those of music, in proper sequence for reading. The apparatus comprises a series of rigid panel members rectangular in configuration and transparent in appearance, each of the panel members being formed having a thin pocket chamber open at the top and extending longitudinally from top to bottom of the panel member for holding a printed sheet contained therein. The panel members are aligned side-by-side and successive panel members are pivotally coupled together along immediately adjacent edges by one or more living hinge members having clamp sections running the length of the hinge members on opposite sides thereof to engage the respective edges and a flexible intermediate web extending between the clamp sections. In this articulated assembly, successive panel members fold relative to each other and may be selectively deployed in a manner that allows successive sheets of music or the like to be easily presented to the reader in proper sequence.

### CROSS-REFERENCE TO RELATED APPLICATION

This application is a continuation-in-part of provisional patent application Ser. No. 61/633,035 filed Feb. 3, 2012 for Multi-Sheet Reading Apparatus.

### BACKGROUND OF THE INVENTION

The present invention relates to devices for supporting printed sheets of paper or the like for reading and, more particularly, to an improved multi-sheet reading apparatus for presenting successive printed sheets, such as those of music, in proper sequence for reading by the user.

In the performance of musical works, musicians often need to turn the pages of their sheet music quickly and in proper order as they play or read from the music in order to avoid a mistake or interruption in the performance. This seemingly simple task of turning successive pages of sheet music while performing has however been problematic for years, especially when the sheet music is loose and unbound. When placed on the support ledge of a piano or organ or on a separate music stand, the loose sheet music can not only be easily displaced and fall from the stand but also be very difficult for the musician to selectively grasp and quickly turn in the right sequence, especially when the pages rest closely against each other. While some self-help measures have been taken by musicians over the years to cut, fold or otherwise physically alter the pages to aid in their manipulation, without mechanical means to assist the musician in this task of turning successive pages of unbound sheet music while playing, the work of the musician may be distracted and the overall performance diminished.

Prior art devices have been designed and developed which afford assistance to musicians in holding and turning both bound and unbound sheet music. An example of such a device for use with bound sheet music is the apparatus described in U.S. Pat. No. 4,655,427 to Lamb. In Lamb, the apparatus comprises a holder having left and right pockets formed internally of backing members for firmly grasping music pages which are not presently being played, leaving free those pages which are to be played. Stiffening members are further provided in the form of transparent envelopes for each free page to ensure its laying flat against the held pages. While the Lamb apparatus may work effectively with a music book or like set of bound pages, it does not afford assistance in reading successive unbound sheets of music.

A prior art sheet music holder designed for use with unbound sheets, is the apparatus described in U.S. Pat. No. 1,261,362 to Cook. In Cook, a pair of solid cover panels are connected by a hinge to open and close along their inner longitudinal edges and are combined with separate pairs of main and auxiliary leaves, each with transparent panes connected to swing relative to the cover panels and further interconnected by hinge strips between each of the leaves along their inner longitudinal edges so that they may open and close together with the cover panels. Through a complicated set of engagement mechanisms, the separately swinging main and auxiliary leaves may be latched together and fastened to the cover panels so that sheets of music placed on the cover panels and between the main and auxiliary panels may be read in progression. The music sheet holder apparatus of Cook and others like it in the prior art that serve to support and hold a plurality of unbound music sheets for progressive reading are found very cumbersome; relatively difficult to handle and carry about, and generally do not afford smooth and easy manipulation by the musician. Therefore, a need exists for an improved multi-sheet support apparatus that will hold individual printed sheets, such as those of music, in a flexible and foldable structure, and present successive printed sheets in proper sequence for reading.

### SUMMARY OF THE INVENTION

Accordingly, it is a general purpose and object of the present invention to provide an improved multi-sheet support apparatus for presenting successive printed sheets, such as those of music, in proper sequence for reading by the user.

A more particular object of the present invention is to provide an improved music reading apparatus for holding separate music sheets in an articulated assembly that facilitates their successive presentation to a musician while performing a musical work.

Another object of the present invention is to provide an improved music reading apparatus that is simple for a musician to handle and easy to for the musician to manipulate while performing so that he or she may progress though the musical work without interruption.

Still another object of the present invention is to provide an improved music reading apparatus that is lightweight and portable and easily stored when not in use.

A still further object of the present invention is to provide an improved music reading apparatus that is inexpensive to manufacture in its component parts, simple to assemble, and easy to use.

Briefly, these and other objects of the present invention are accomplished by an improved multi-sheet reading apparatus for presenting successive printed sheets, such as those of music, in proper sequence for reading by the user. The apparatus comprises a series of rigid panel members rectangular in configuration and transparent in appearance, each of the panel members being formed having a thin pocket chamber open along the top of each panel member, the pocket chamber being rectangular in shape and extending longitudinally from top to bottom of the panel member for holding a printed sheet contained therein. The panel members are aligned side-by-side and successive panel members are pivotally coupled together along immediately adjacent edges by one or more living hinge members having clamp sections running the length of the hinge members on opposite sides thereof to engage the respective edges and a flexible intermediate web extending between the clamp sections. In this articulated assembly, successive panel members fold relative to each other and may be selectively deployed in a manner that allows successive sheets of music or the like to be easily presented to the reader in proper sequence.

For a better understanding of these and other aspects of the present invention, reference should be made to the following detailed description taken in conjunction with the accompanying drawings in which like reference numerals and character designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1 is a front elevation view of a preferred embodiment of the present multi-sheet reading apparatus in a deployed state and positioned for use disposed upon a music stand;

FIG. 2 is a front perspective view from above of the multi-sheet reading apparatus of FIG. 1, shown separate from the music stand and in a partially folded state with selected music sheets removed;

FIG. 3 is a partial sectional view of the multi-sheet reading apparatus of FIG. 2 taken along the line 3-3 therein;

FIG. 4 is a top perspective view of the present multi-sheet reading apparatus of FIGS. 1 and 2 shown in a fully folded state;

FIG. 5 is a front perspective view from above of an alternate embodiment of the present multi-sheet reading apparatus shown in a partially folded state; and

FIG. 6 is a side elevation view of the present multi-sheet reading apparatus showing a notched feature optionally provided to aid in the placement and removal of sheet material (in phantom) from the apparatus.

### DESCRIPTION OF THE INVENTION

The following serves to describe a preferred embodiment of the present invention and the best presently contemplated mode of its production and practice. This description is further made for the purpose of illustrating the general principles of the invention but should not be taken in a limiting sense, the scope of the invention being best determined by reference to any associated claims.

Referring to the drawings, the following is a list of structural components of the present multi-sheet reading apparatus, generally designated 10, and those associated structural elements shown employed in connection with the present invention:
10 multi-sheet reading apparatus;
12a first panel member;
12b second panel member;
12c third panel member;
12d fourth panel member;
14a first living hinge member;
14b second living hinge member;
14c third living hinge member;
16a first hinge clamp section;
16b second hinge clamp section;
18 intermediate web;
20 alternate multi-sheet reading apparatus;
22a first panel member;
22b second panel member;
22c third panel member;
22d fourth panel member;
24a first living hinge member;
24b second living hinge member;
24c third living hinge member;
26a first hinge clamp section;
26b second hinge clamp section;
28 intermediate web;
32a notched panel member;
33 notched section;
M music stand;
P pocket chamber; and
S sheet of music.

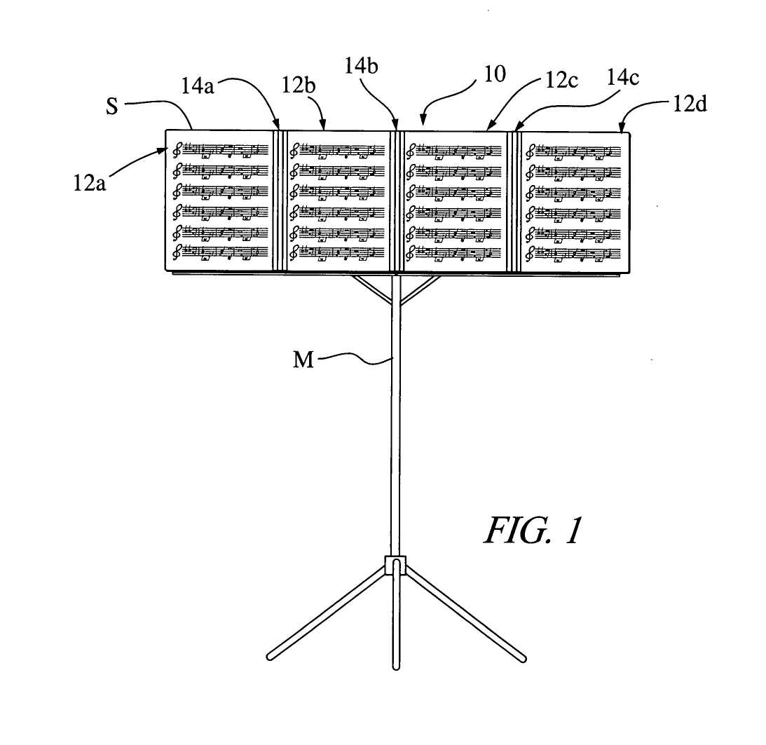

Referring initially to FIG. 1, the present multi-sheet reading apparatus 10 is shown in a deployed configuration and disposed upon a conventional music stand M for intended use by a musician (not shown). In accordance with the present invention, the present multi-sheet reading apparatus 10 comprises a series of rigid to semi-rigid panel members 12a, 12b, 12c and 12d, each similarly rectangular in form and transparent in appearance. The rectangular dimensions of the panel members may vary based upon the size of the music sheet S or other printed sheet material intended for use and generally are slightly oversized in length and width to accommodate the particular printed sheet employed. Each of the panel members 12a, 12b, 12c and 12d are preferably made from separate sheets of a clear thermoplastic material, such as an acrylic or polyvinyl chloride, that are cut to shape and bonded along both opposite sides and the bottom edge thereof to form a thin pocket chamber P rectangular in shape and made to extend longitudinally from top to bottom within each panel member. The pocket chamber P is thus open along the top edge of each panel member 12a, 12b, 12c and 12d and serves to hold one or more loose sheets of music S or like printed sheet material contained within the panel member and fully visible from the exterior thereof. The number of panel members 12 combined in the present multi-sheet reading apparatus 10 may range from two or more depending upon the number of music sheets S in a musical work or other printed sheet material required to be read by the user.

The series of panel members 12a, 12b, 12c and 12d are aligned side-by-side in succession and successive panel members are pivotally coupled together along immediately adjacent edges by respective living hinge members 14 disposed and connected between the successive panel members. According to the Society of Plastics Engineers Encyclopedia Directory, a “living hinge” is a thin flexible hinge or flexure bearing made from plastic that joins two rigid plastic parts together, allowing them to bend along the line of the hinge. As seen in FIG. 1, a first living hinge member 14a pivotally couples the first panel member 12a to the second panel member 12b; a second living hinge member 14b pivotally couples the second panel member 12b to the third panel member 12c; and a third living hinge member 14c pivotally couples the third panel member 12c to the fourth panel member 12d. As described in greater detail below, each of the living hinge members 14a, 14b and 14c is constructed and oriented in its attached position longitudinally between the respective successive panel members so as to provide a flexible bridge between the successive panels that allows a full closure and fold of the panels together in one direction.

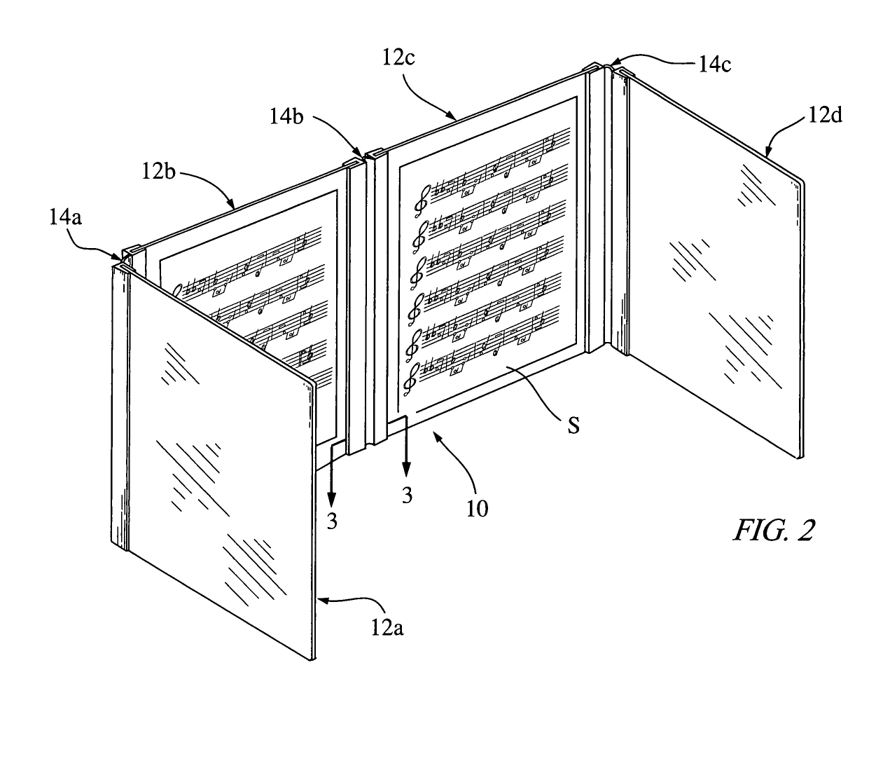

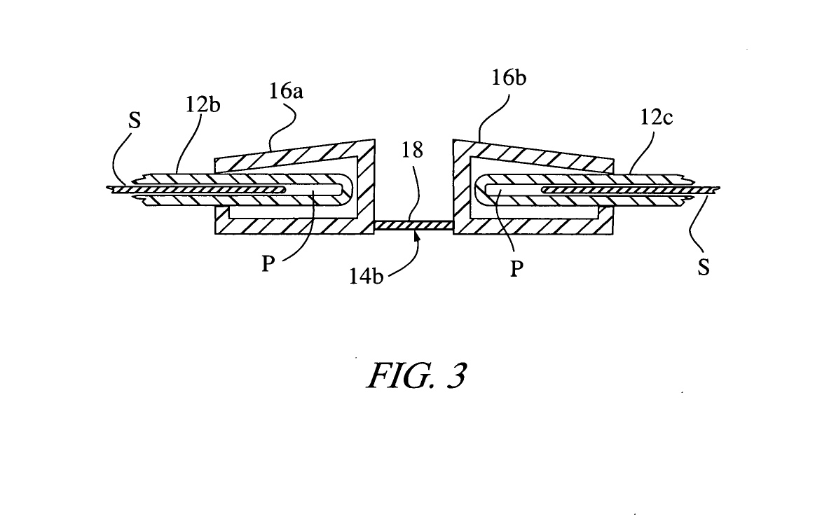

Referring now to FIGS. 2 and 3, each living hinge member 14a, 14b and 14c is secured in place along the intermediate longitudinal edges of the successive panel members 12a, 12b, 12c and 12d and is adapted to be removable therefrom at the option of the user. It is preferred that the length of each living hinge member 14a, 14b and 14c be sufficient to extend the full length of the associated panel members 12a, 12b, 12c and 12d, as shown in the drawing figures, to provide maximum strength and durability to the assembled reading apparatus 10. It should be understood, however, that within the scope of the present invention, the respective hinge members 14a, 14b and 14c may also be made in shorter lengths or segmented forms spaced apart along the intermediate longitudinal edges of the successive panel members 12a, 12b, 12c and 12d and still function equally well to provide a flexible bridge connection therebetween. As seen particularly in FIG. 2, the first panel member 12a is capable of swinging inwardly relative to the second panel member 12b on the pivotal connection provided by hinge member 14a, and likewise, the fourth panel member 12d is able to swing inwardly relative to the third panel member 12c on their associated living hinge member 14c, in both respective cases the successive panels being able to fully close and fold onto each other. It should be understood that the central hinge member 14b connected between the second and third panel members 12b and 12c, respectively, is similarly configured and oriented as the outer hinge members 14a and 14b on either side, and thus likewise allows those interconnected interior panel members to fold inwardly and close onto each other.

As best seen in FIG. 3 and its exemplary cross-section of the flexible bridge connection between successive panel members 12b and 12c, each living hinge member 14a, 14b (shown) and 14c is integrally constructed having a pair of hinge clamp sections 16a and 16b oppositely facing and running the length of the hinge member on opposite sides of an intermediate web 18, each living hinge member being preferably made from a durable thermoplastic material, such as an acrylic or polyvinyl chloride. The clamp sections 16a and 16b are preferably semi-rigid forms each having a modified C-shaped profile with its opening to the outside of each that allows the clamp sections to firmly engage the respective edges of the successive panel members 12b and 12c with the music sheet S contained within the respective pocket chambers P, as shown, and thereby pivotally coupling the panel members together. The clamp sections 16a and 16b are preferably engaged by sliding them longitudinally onto the respective edges of the successive panel members 12b and 12c and accordingly, each clamp section may be disengaged and released from the associated panel members by sliding it longitudinally therefrom. The intermediate web 18 is a relatively thin and flexible linear segment that is integrally formed between the clamp sections 16a and 16b and made to extend in substantial alignment with the lower surface edges of the opposed clamp sections, as shown in FIG. 3. This form and disposition of the intermediate web 18 provides an interstitial space between the opposed clamp sections 16a and 16b and allows the clamp sections to swing freely towards each other connected by the web in the direction away from the interstitial space with the flexible web, as a result, bowing in the direction of the interstitial space. This resultant motion of the component sections of the living hinge member 14b serves to swing the connected panel members 12b and 12c together and fold them onto each other in a forward direction in reference to the view of FIG. 2.

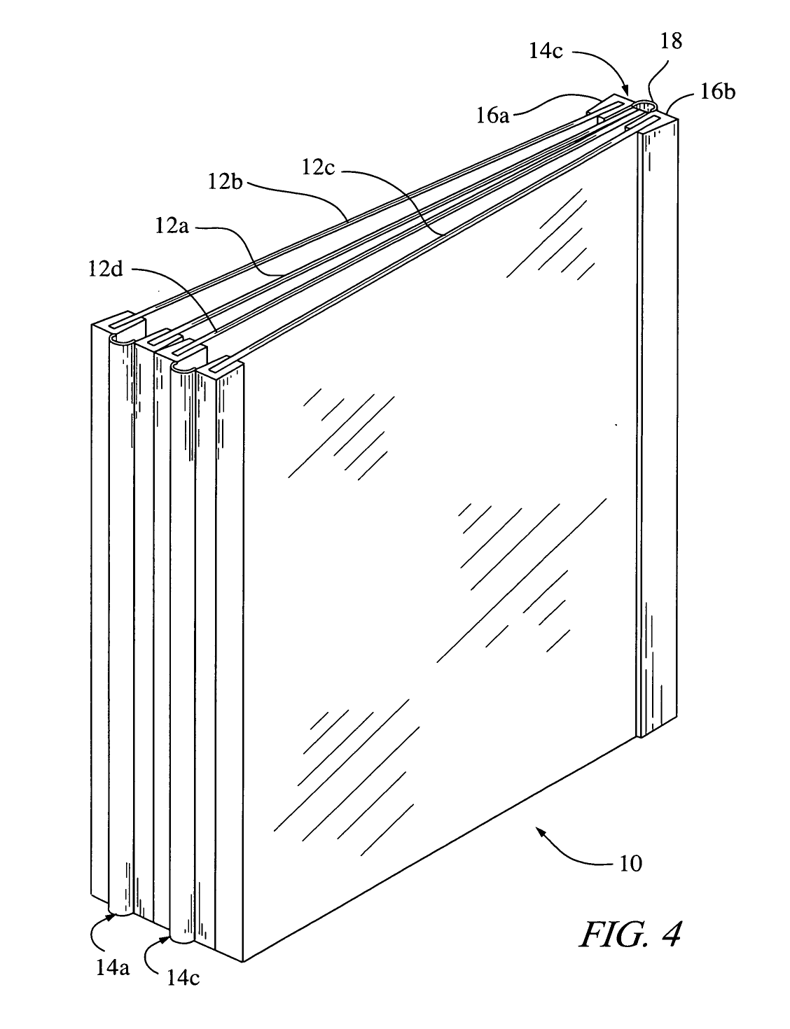

Referring now to FIG. 4 in conjunction with FIGS. 2 and 3, the multi-sheet reading apparatus 10 is capable of being folded together into a compact and easy to carry state. Proper folding of the present apparatus 10 into the closed configuration depicted in FIG. 4 would commence with the inward folding of the outer panel members, the first panel member 12a onto the second panel member 12b via the associated living hinge member 14a and the fourth panel member 12d onto the third panel member 12c via the associated living hinge member 14c. Thereafter, the combined sets of folded panel members 12a and 12b, and 12c and 12d, respectively, on either side of the central living hinge member 14c, are in turn folded inward and fitted together into the closed configuration of FIG. 4.

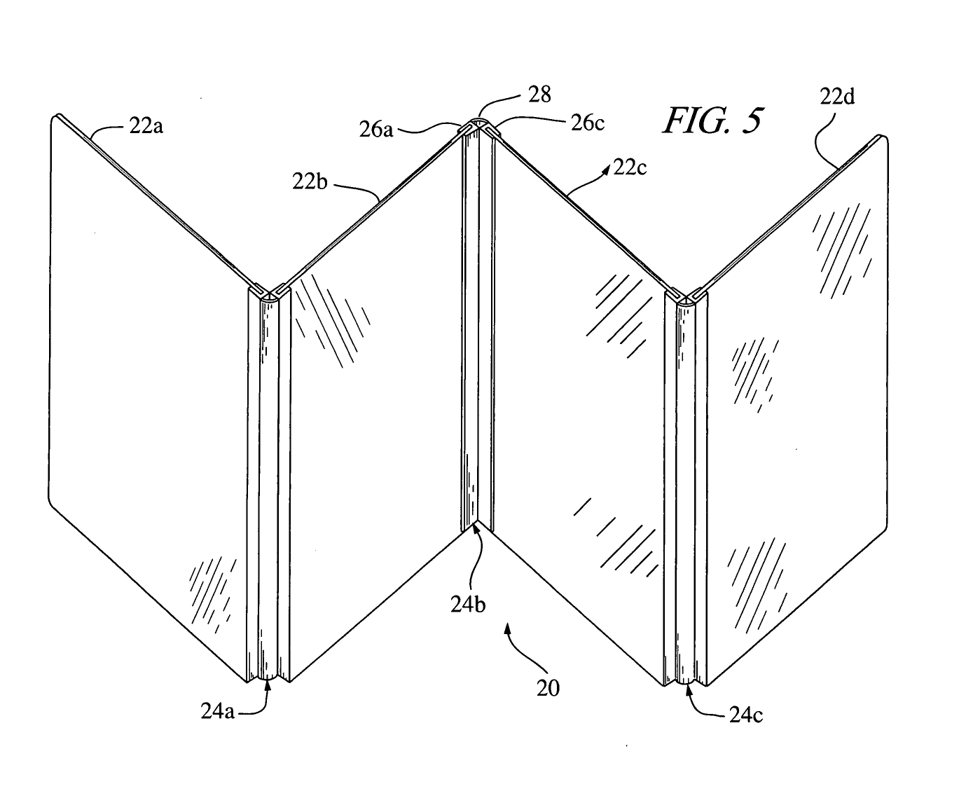

Referring now to FIG. 5, an alternate embodiment of the present multi-sheet reading apparatus, generally designated 20, comprises a modified assembly of the respective panel members 22a, 22b, 22c and 22d that is accordion-like in its folding motion. In this accordion-like embodiment, the first and second panel members 22a and 22b are pivotally connected by a living hinge member 24a that is similar to in construction but reversed in orientation from that of the living hinge member 14a used to pivotally connect the first and second panel members 12a and 12b in the preferred embodiment of the apparatus described above and shown in FIGS. 1-4. This reversed orientation of the living hinge member 24a involves the disposition and engagement of the hinge member with the associated panel members 22a and 22b having the intermediate web 28 and resulting interstitial space between the respective clamp sections 26a and 26c in reverse positions so as to promote a folding of the first and second panel members in an opposite direction from those of the multi-sheet reading apparatus 10. Furthermore, the third and fourth panel members 22c and 22d of apparatus 20 are likewise pivotally connected in a similarly reverse fashion by a living hinge member 24c similar in construction but reversed in orientation from that of the living hinge member 14c used to pivotally connect the third and fourth panel members 12c and 12d in the above-described reading apparatus 10. With the central living hinge member 24b being the same in its construction and orientation to that of hinge member 14b, the resulting folded motion of the central panel members 22b and 22c is the same as in the preferred embodiment of apparatus 10 but the outer panel members 22a and 22d will fold inwardly in opposite directions and the assembly will open and close as like an accordion.

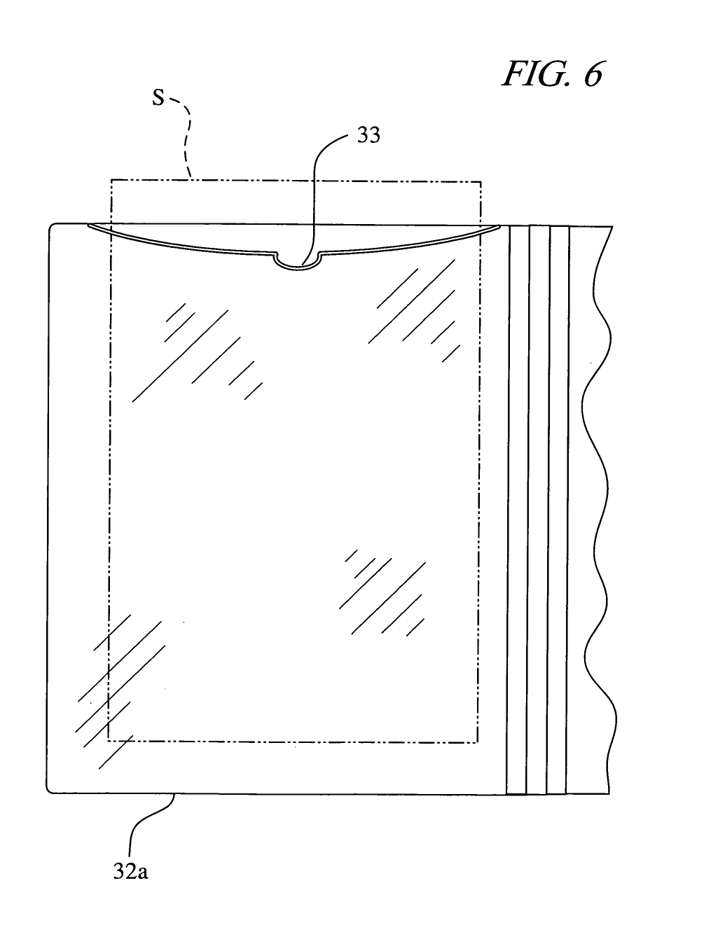

Referring now to FIG. 6, a notched section 33 may be provided along the top edge of any one panel member 32a or all of the panel members in the assembled apparatus to aid in the proper placement of the music or other sheet material S in the pocket chamber P of the panel member and to facilitate the removal of the sheet. The notched section 33 is preferably sized and shaped sufficient to allow finger access to the pocket chamber P and would be formed by conventional means either in the original construction of the panel members or subsequently by cutting out and removing the necessary section.

Therefore, it is apparent that the described invention provides an improved multi-sheet support apparatus for presenting successive printed sheets, such as those of music, in proper sequence for reading by the user. More particularly, the disclosed invention provides an improved music reading apparatus for holding separate music sheets in an articulated assembly that facilitates the successive presentation of the sheets to a musician while performing a musical work. In the disclosed embodiments, the present invention provides a music reading apparatus that is easy for a musician to handle and to manipulate while performing so that he or she may progress though the musical work without interruption. Furthermore, the assembled construction of the disclosed music reading apparatus is lightweight and portable and easily stored when not in use. In addition to music sheets, the present reading apparatus will suitably support for presentation various other printed instructional sheets, such as cooking recipes, workshop processing, and knitting and embroidery instructions that need to be read in a protective format.

Obviously, other embodiments and modifications of the present invention will readily come to those of ordinary skill in the art having the benefit of the teachings presented in the foregoing description and drawings. Alternate embodiments of different shapes and sizes, as well as substitution of known materials or those materials which may be developed at a future time to perform the same function as the present described embodiment are therefore considered to be part of the present invention. Furthermore, certain modifications to the described embodiment that serve to benefit its usage are within the scope of the present invention. Accordingly, it is understood that this invention is not limited to the particular embodiment described, but rather is intended to cover modifications within the spirit and scope of the present invention as expressed in the appended claims.

What is claimed is:

1. An articulated support apparatus for presenting successive printed sheets in proper sequence for reading, comprising:
a series of panels aligned side-by-side and pivotally coupled in succession, each of the panels being rectangular in configuration and transparent in appearance and further formed having a pocket chamber extending therein for containing a selected one of the printed sheets; and
a plurality of hinge members operatively connected between successive ones of said panels along immediately adjacent edges thereof, each of said hinge members being constructed having a pair of clamp sections openly facing along opposite sides of the hinge member and an intermediate web section integrally formed between the clamp sections.

2. An articulated support apparatus according to claim 1, wherein said panels are closed along opposite sides and a bottom edge thereof to form the pocket chamber in a rectangular configuration extending within each of said panels with the pocket chamber being open along the top edge of each panel.

3. An articulated support apparatus according to claim 2, wherein said panels are further formed having a notched section along the top edge of each of said panels to facilitate placement and removal of the printed sheets into and from the pocket chamber.

4. An articulated support apparatus according to claim 1, wherein each of the clamp sections is formed having a substantially C-shaped profile sized to releasably engage the immediately adjacent edges of the successive ones of said panels.

5. An articulated support apparatus according to claim 4, wherein each intermediate web section comprises a linear segment integrally formed between respective pairs of the clamp sections and positioned to provide an interstitial space therebetween so that the clamp sections may move towards each other in the direction away from the interstitial space with the intermediate web section bowing in the direction of the interstitial space.

6. A device for supporting a series of printed sheets intended to be read by a user in sequence, comprising:
a plurality of panel members rectangular in configuration and disposed side-by-side in succession, successive ones of said panel members being pivotally coupled together along immediately adjacent sides, each of said panels members having a pocket chamber formed therein to hold one of the printed sheets; and
a plurality of living hinge members operatively connected between successive ones of said panels along immediately adjacent edges thereof so that said panel members fold relative to each other and may be selectively deployed in a manner allowing the printed sheets to be displayed to the user in proper sequence.

7. A support device for printed sheets according to claim 6, wherein each of said living hinge members comprises:
a pair of clamp sections disposed along opposite sides of said living hinge member, each of the clamp sections being formed having a substantially C-shaped profile outwardly facing and sized to releasably engage the immediately adjacent edges of the successive ones of said panel members; and
an intermediate web section integrally formed between the clamp sections to to provide a flexure bearing for movement of the clamp sections.

8. A support device for printed sheets according to claim 7, wherein each intermediate web section comprises a linear segment formed between respective pairs of the clamp sections and positioned to provide an interstitial space therebetween so that the clamp sections may move towards each other in the direction away from the interstitial space with the intermediate web section bowing in the direction of the interstitial space.

9. A support device for printed sheets according to claim 6, wherein said living hinge members are connected between successive ones of said panel members so that said panel members are deployed in an accordion-like manner.

10. A support device for printed sheets according to claim 6, wherein said panel members are closed along opposite sides and a bottom edge thereof forming the pocket chamber within each panel member with the chamber being open along the top edge of each panel member.

11. A support device for printed sheets according to claim 10, wherein said panel members are further formed having a notched section along the top edge of each of said panels to facilitate placement and removal of the printed sheets into and from the pocket chamber.
